(19) United States
(12) Patent Application Publication
(10) Pub. No.: US 2020/0070543 A1
(43) Pub. Date: Mar. 5, 2020

(54) MAGNETIC KEYBOARD DOMES

(71) Applicant: HEWLETT- PACKARD DEVELOPMENT COMPANY, LP., HOUSTON, TX (US)

(72) Inventor: CHIH-CHEN HUNG, TAIPEI CITY (TW)

(21) Appl. No.: 16/325,274

(22) PCT Filed: Oct. 13, 2016
(86) PCT No.: PCT/US2016/056815

§ 371 Date: Feb. 13, 2019

(51) Int. Cl. B41J 5/12; G06F 3/02; H01H 13/705

(52) U.S. Cl. CPC B41J 5/12; G06F 3/0202; H01H 2215/012; H01H 2227/034; H01H 13/705

(57) ABSTRACT

Example implementations relate to magnetic keyboard domes. In an example, a keyboard dome includes a dome with an exterior surface, and a metal magnetic pad on the exterior surface of the dome to guide the dome to a keyboard membrane.

### BACKGROUND

Keyboards are utilized in a variety of applications. For example, keyboards may be utilized as an input device to provide letters, numbers and/or characters to a computer, among other possibilities.

### BRIEF DESCRIPTION OF THE DRAWINGS

FIG. 1 illustrates an example of a keyboard dome according to the disclosure.

FIG. 2 illustrates an exploded view of an example of a keyboard dome according to the disclosure.

FIG. 3 illustrates a section view of an example of an apparatus comprising a keyboard membrane and a keyboard dome according to the disclosure.

FIG. 4 illustrates an example of a membrane cover comprising a guiding opening according to the disclosure.

FIG. 5 illustrates an example of a keyboard membrane according to the disclosure.

FIG. 6 illustrates a flow diagram of an example of a method of manufacture of a keyboard dome according to the disclosure.

### DETAILED DESCRIPTION

A portion of keyboard manufacture may be manually performed such that automatic keyboard manufacturing is not employed and/or desired. Particularly, individual keyboard domes may be manually coupled and in individual basis to respective locations of a keyboard membrane as part of manufacture of a keyboard. However, coupling of the individual keyboard domes on an individual basis to respective locations of the keyboard may undesirably be subject to errors in placement due to the manual nature of the process and/or the coupling the keyboard domes on an individual basis. Such manual coupling of the keyboard domes on an individual basis may result in positioning a keyboard dome in an undesired location and/or may cause incomplete manufacture such that the keyboard including the manually positioned keyboard dome may not function as intended, and/or increased keyboard manufacturing costs due to the nature of the manual placement and/or the incomplete manufacture of the keyboard. As such, ensuring that a keyboard dome is automatically (without direct manual guiding of individual keyboard domes) and properly guided to a desired location of a keyboard membrane may be desirable.

Examples of the disclosure include magnetic keyboard domes, keyboard membranes to which the magnetic keyboard domes are guided to, and methods of manufacture of keyboard domes. Desirably, the magnetic keyboard domes can guide the keyboard domes to an intended location of a keyboard membrane and/or facilitate automatic manufacture of a keyboard including the keyboard domes (in contrast to manual approaches such as those manually coupling keyboard domes on an individual basis to a keyboard membrane) while still maintaining a desired stability and performance (e.g., a desired force to fire) of keys of the keyboard.

As used herein, a magnetic keyboard dome refers to a keyboard dome with a metal magnetic pad coupled to a surface (e.g., a first surface) of the keyboard dome. Keyboard membranes as used herein refer to those membranes suitable in and/or as a keyboard. As mentioned, magnetic keyboard domes, in various examples, may be automatically guided to a desired location of a keyboard membrane (e.g., without manual coupling of individual keyboard domes) via the metal magnetic pad.

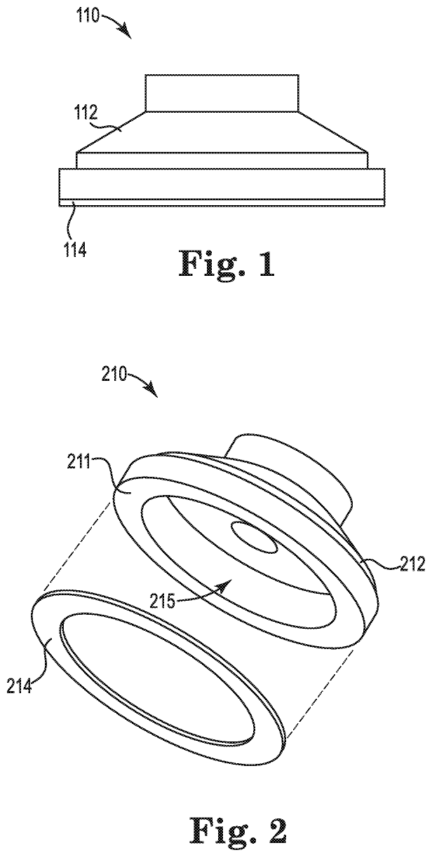

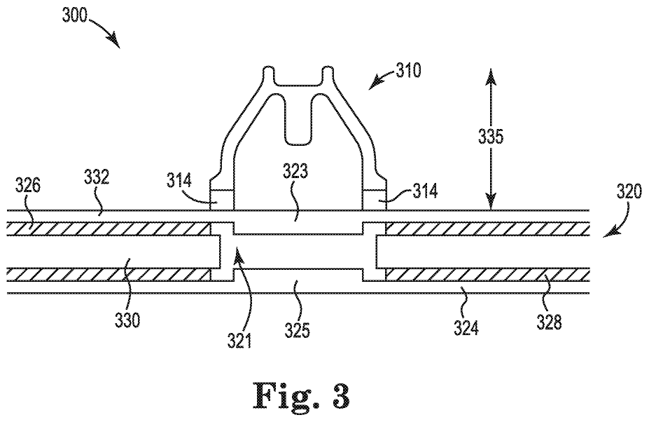

FIG. 1 illustrates an example of a keyboard dome 110 according to the disclosure. As illustrated in FIG. 1, the keyboard dome 110 can comprise a dome 112 and a metal magnetic pad 114. In a number of examples, the keyboard dome 110 may comprise the metal magnetic pad 114 on an exterior surface (e.g., exterior surface 211 as illustrated in FIG. 2) of the dome 112 to guide the dome 112 to a keyboard membrane (e.g., a keyboard membrane 320 as described here in relation to FIG. 3).

A thickness of the magnetic pad 114 may vary as desired. For example, the magnetic pad 114 can be substantially less thick than the dome 112 so as not to disturb the performance of the keyboard dome (e.g., forming a contact between the keyboard dome 112 and the keyboard membrane) with regard to the keyboard membrane, while sufficient to properly guide the dome 112.

In a number of examples, the metal magnetic pad 114 can be non-removably coupled to the exterior surface (e.g., exterior surface 211 as illustrated in FIG. 2) of the dome 112 to prevent the dome 112 from being inadvertently removed from the keyboard membrane when the dome 112 is guided and coupled to the keyboard membrane via the metal magnetic pad 114.

The dome 112 can be comprised of a resilient material. For example, the resilient material can be further comprised of a rubber, silicon rubber, or a combination thereof, among other possibilities. As such, the dome 112 can be displaced responsive to the displacement force applied to a portion of the dome 112 (e.g., upper portion of the dome 112) to be in contact with one surface of the keyboard membrane. The contact may complete a switch within, and trigger a flow of current through the keyboard membrane.

FIG. 2 illustrates an exploded view of an example of a keyboard dome 210 according to the disclosure. A keyboard dome 210, a dome 212, and a metal magnetic pad 214 are analogous to those described in FIG. 1 (e.g., keyboard dome 110, dome 112 and, metal magnetic pad 114).

The metal magnetic pad 214 can be coupled to a lower exterior surface of the dome 212 as illustrated in FIG. 2. As such, when guiding the keyboard dome 212 to, via the metal magnetic pad 214, the keyboard membrane, the exterior surface 211 can be coupled to, via the metal magnetic pad 214, a surface of the keyboard membrane while another exterior surface of the dome 210 can remain free of contact until a respective keycap is manufactured on the dome 210.

In a number of examples, the surface 211 of the dome 212 can be of a hollow shape. For example, the surface 211 may comprise a hole 215 such that an innermost surface of an upper portion of the dome 212 can be in contact with a surface of the keyboard membrane when a displacement force is applied to the keyboard dome 210. Displacement of the keyboard dome 210, and its contact with the keyboard membrane is further described herein in relation to FIG. 3.

The metal magnetic pad 214 may cover a portion of the surface 211, among other possibilities. For example, as illustrated in FIG. 1, the metal magnetic pad 214 can cover a portion of the surface 211 that is not the hole (e.g., 215). Notably, covering a portion of the surface 211 provides benefits such as not disturbing performance of the keyboard dome 210 (e.g., being properly in contact with the keyboard membrane) as desired while properly guiding the dome 212 to the keyboard membrane when being manufactured,

FIG. 3 illustrates a section view of an example of an apparatus 300 comprising a keyboard membrane 320 and a keyboard dome 310 according to the disclosure. As used herein, the apparatus 300 refers to an assembly included in an input device such as a keyboard and/or a laptop, among other possibilities. The keyboard dome 310 can comprise a metal magnetic pad 314 that is analogous to that described in relation to FIG. 1 (e.g., metal magnetic pad 114). The keyboard membrane 320 includes a first circuit 332, a second circuit 324, a first adhesive layer 326, a second adhesive layer 328, and a spacer 330. However, while FIG. 3 illustrates the keyboard membrane 320 as including a particular number of elements, the disclosure is not so limited. Elements shown in the various figures herein can be added, exchanged, and/or eliminated so as to promote various aspects of the keyboard dome 310 according to the disclosure. For example, while FIG. 3 illustrates the keyboard membrane as not including the keycap guide, in some examples, the keycap guide can be included in the keyboard membrane 320 such that the keycap guide can be in contact with a keycap to guide the keycap.

The keyboard dome 310 is positioned on a particular location of the keyboard membrane 320 and comprises the metal magnetic pad 314 to guide the keyboard dome 310 to the particular location of the keyboard membrane 320. In a number of examples, the metal magnetic pad 314 is positioned on an exterior surface of the keyboard dome to contact and non-removably couple the keyboard dome 310 to the particular location of the keyboard membrane. As described herein, the metal magnetic pad 314 can guide the keyboard dome 310 to the particular location (e.g., a particular exterior surface) of the keyboard membrane 320 via a magnetic field selectively generated on the particular location of the keyboard membrane 320.

The keyboard membrane comprises a circuit (e.g., a circuit formed by the first circuit 332 and the second circuit 324). The first circuit 332 can include a first conductive trace (not shown for ease of illustration) and a first key contact 323. The first conductive trace is coupled to the first key contact 323. The second circuit 324 can include a second conductive trace (not shown for ease of illustration) and a second key contact 325. The second conductive trace is coupled to the second key contact 325. The conductive traces, in some examples, are silver conductive traces. However, the disclosure is not so limited. Rather, the conductive traces can be formed of a variety of suitable materials including silver and carbon and/or combinations thereof, among other types of suitable materials.

The second key contact 325 is to contact the first key contact 323, for example, when the first key contact 323 of the first circuit 332 is displaced by a displacement force applied to the keyboard dome (e.g., via a displacement for applied to a keyboard dome), among other possibilities, to contact the first key contact 323 and the second key contact 325. For instance, the keyboard dome 310 may be displaced along a path of travel 335 such that the first key contact 323 may also be displaced along the same path 335 that is substantially perpendicular to the first circuit 332 and/or the second circuit 324. Contact between the first key contact 323 and the second key contact 325 can include causing the first key contact 323 to move along the path of travel 335 to be positioned adjacent to and/or substantially adjacent to the second key contact 325 to couple (e.g., electrically couple) the first key contact 323 with the second key contact 325.

The keyboard membrane 320 can include a first adhesive layer 325 disposed on at least a portion of the spacer 330. Similarly, the keyboard membrane 320 can include a second adhesive layer 328 disposed on at least a portion of the spacer 330. An adhesive included in the first adhesive layer 326 and/or the second adhesive layer 328 can be a solvent based adhesive, a pressure sensitive adhesive, a contact adhesive, a multi-part adhesive, and/or a one-part adhesive, among other types of adhesives suitable to promote a keyboard dome 320.

The keyboard membrane 320 can include the first adhesive layer 326, the second adhesive layer 328, and the spacer 330 such that the spacer 330 is positioned between the first circuit 332 and the second circuit 324, as illustrated in FIG. 3. For example, as, as illustrated in FIG. 3, the spacer 330 can be positioned between the first adhesive layer 326 and the second adhesive layer 328 such that each are positioned between the first circuit 332 and the second circuit 324. However, in some examples the keyboard membrane 320 can be formed without a spacer,

The spacer 330 can be formed of plastic such as polyethylene terephthalate, among other materials and/or combinations of materials. The spacer 330 can promote various performance characteristics, for example, disposition of the first circuit 332 and the second circuit 324 to have a desired force to fire (i.e., an amount of force applied to the keyboard dome 310 of the keyboard membrane 320 sufficient to complete a switch formed between the first key contract 323 and the second key contract 325. The spacer 330 can form a portion of a distance separating the first circuit 332 from the second circuit 324.

The keyboard membrane 320 includes an opening 321 to permit the first key contact 323 to contact the second key contact 325. For example, the opening 321 can extend from the first key contact 323 of the first circuit 332 to the second key contact 325 of the second circuit 324 through each of the first adhesive layer 326 and the second adhesive layer 328, and the spacer 330, as illustrated in FIG. 3. Notably, at least of portion of the opening 321 extends from the first key contact 323 to the second key contact 325.

Electrical bridges can provide power to the first circuit 332 and/or the second circuit 324. Electrical bridges can couple a portion of the keyboard membrane 320 to another portion of the keyboard membrane 320.

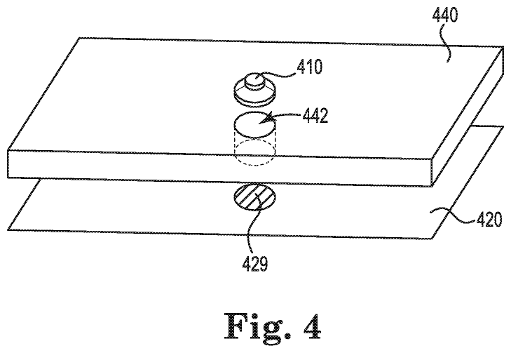

FIG. 4 illustrates an example of a membrane cover 440 comprising a guiding opening 442 according to the disclosure. The keyboard dome 410 is analogous to those described in FIG. 1 and FIG. 2 (e.g., Keyboard dome 110 and 210).

The keyboard dome (e.g., 440) with a metal magnetic pad on one surface can be guided to the keyboard membrane (e.g., 420) via a magnetic field selectively generated on a particular location of the keyboard membrane, as described herein. For example, the magnetic field can be selectively generated on a location 429 of the keyboard membrane 420 such that the magnetic field attracts the keyboard dome to the location 429.

In guiding the keyboard dome 410 to the location 429 of the keyboard membrane 420, the keyboard membrane 420 can comprise the membrane cover 440 comprising a guiding opening 442. For example, the membrane cover 440 can be placed on the keyboard membrane 420 such that the guiding opening 442 of the membrane cover 440 can expose the location 429 to the keyboard dome 410 while covering other locations of the keyboard membrane 420. The membrane cover 440 can be comprised of a plastic, among other possibilities.

In some examples, the membrane cover 440 may comprise a plurality of guiding openings. For example, the membrane cover 440 having a plurality of guiding openings may be utilized to simultaneously guide a plurality of keyboard domes to a respective location of the keyboard membrane, as described herein.

In a number of examples, the guiding opening 442 of the membrane cover 440 can be of a particular shape to guide a particular keyboard dome to the location 429 of the keyboard membrane via the guiding opening. For example, a surface area of the guiding opening 442 that receives the keyboard dome 410 first may be suitable to a size of the keyboard dome 442. That is, when the size of the keyboard dome 442 is particularly large (e.g., space bar, enter, shift, etc.), the guiding opening may be enlarged enough to receive the large keyboard dome.

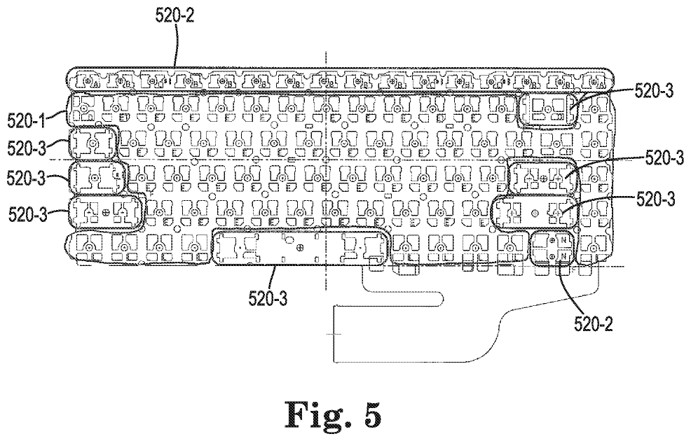

FIG. 5 illustrates an example of a keyboard membrane 520 with highlighted portions to which various types of keyboard domes to be guided. The keyboard membrane 520 are analogous to those described in relation to FIG. 3 (e.g., keyboard membrane 320).

A portion 520-1 describes locations to which a set of a plurality of keyboard domes (e.g., that may be in same size and shape) can be guided. For example, the portion 520-1 can utilizes mid-size keyboard domes suitable to keycaps such as alphabets, numbers, etc.

A portion 520-2 describes locations to which another set of a plurality of keyboard domes can be guided. A set of the plurality of keyboard domes suitable to the portion 520-2 may be in same size and shape. For example, the portion 520-2 can utilize small-size keyboard domes suitable to keycaps such as function keys.

A portion 520-3 describes locations to which another set of a plurality of keyboard domes that is particularly of large size can be guided. For example, the portion 520-3 can utilize large-size keyboard domes suitable to keycaps such as spacebar, shift, caps lock, tab, enter, backspace, etc.

In some examples, a membrane cover may comprise a plurality of guiding openings to receive keyboard domes that are in same size and shape. In some examples, the membrane cover may comprise a plurality of openings to receive keyboard domes suitable to the portion 520-1. In another example, the membrane cover may comprise a plurality of openings to receive keyboard domes suitable to the portion 520-2. As such, the membrane cover can be utilized to simultaneously guide a plurality of keyboard domes that are in same size and shape, although examples are not limited so. Utilizing a membrane cover comprising a plurality of guiding openings may reduce manufacturing time and costs.

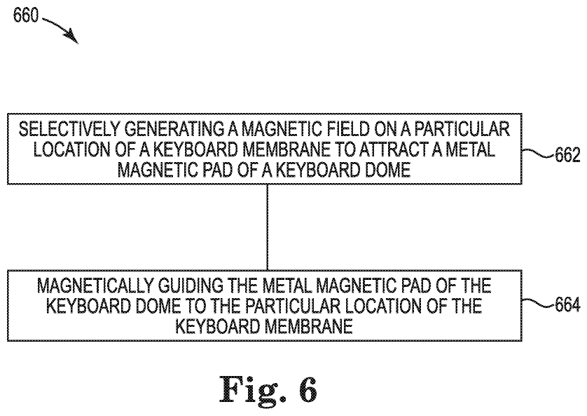

FIG. 6 illustrates a flow diagram of an example of a method 660 of manufacture of a keyboard dome according to the disclosure. As illustrated at 662, the method 660 includes selectively generating a magnetic field on a particular location of a keyboard membrane to attract a metal magnetic pad of a keyboard dome. As used herein, selectively generating a magnetic field refers to generating the magnetic field on a desired (e.g., partial or entire) location of a keyboard membrane. A strength of the magnetic field and/or locations on which the magnetic field is to be generated can be adjusted, for example, to control a number of keyboard domes to be attracted. Locations on which the magnetic field is generated need not be continuous. That is, a first magnetic field can be selectively generated on a first location, and a second magnetic field can be generated on a second location that is apart from the first location.

A magnetic field can be generated on either side the keyboard membrane. In some examples, a keyboard dome can be guided to a side of a keyboard membrane via a magnetic field generated on another side of the keyboard membrane. Generating the magnetic field on an opposite side (e.g., compared to a side to which the keyboard dome is guided) of the keyboard membrane may provide benefits such as not disturbing a physical contact between the keyboard membrane and the keyboard dome. However, examples are not so limited. For example, a magnetic field can be generated on a side to which the keyboard dome is guided.

As illustrated at 664, the method 660 can include magnetically guiding the metal magnetic pad of the keyboard dome to the particular location of the keyboard membrane. As used herein, magnetically guiding the metal magnetic pad refers to attracting the metal magnetic pad via a force generated by the magnetic field that pulls on the metal magnetic pad. As such, the keyboard dome on which the magnetic metal pad is coupled to can be magnetically guided to the location of the keyboard membrane on which the magnetic field is selectively generated. Magnetically guiding a keyboard dome provides benefits such as automatically and properly guiding a keyboard dome to a desired location of a keyboard membrane, and reducing errors due to a manual nature of a process and/or manufacturing costs.

In some examples, the method 660 can include providing a first membrane cover including a guiding opening to guide the keyboard dome to the particular location of the keyboard membrane via the guiding opening. Further, the method 660 can include placing the first membrane cover on the keyboard membrane such that the particular location is exposed via the guiding opening. As described herein, the first membrane cover may comprise the guiding opening that is of a particular shape suitable to receive a particular shape of a keyboard dome.

Upon placing the membrane cover on the keyboard membrane, the method 660 can include magnetically guiding the metal magnetic pad of the keyboard dome to the particular location of the keyboard membrane via the guiding opening of the membrane cover. For example, when the magnetic field is generated on the particular location of the keyboard membrane that is exposed via the guiding opening of the membrane cover (while covering other locations of the keyboard membrane), the metal magnetic pad can be attracted to the particular location such that the keyboard dome (with the metal magnetic pad) is guided to the particular location via the guiding opening. The guiding opening of the membrane cover provide benefits such as accurately guiding the keyboard dome to a desired location of the keyboard membrane, among other benefits.

In some examples, the method 660 can include providing a second membrane cover for another keyboard dome with a different shape. For example, upon guiding a first keyboard dome (guided via the first membrane cover described herein), the second membrane cover can be placed on the keyboard membrane to guide a second keyboard dome that is of a different shape and to be guided to a different location than that of the first keyboard dome. As such, the second membrane cover can comprise a guiding opening of a different shape and/or that is positioned on a different location of the second membrane cover. As described herein, the method 660 can include using a plurality of different membrane covers to guide a respective keyboard dome. Prior to using a new membrane cover, a pervious membrane cover that is used in a previous guiding process can be removed from the keyboard membrane such that the new membrane can properly expose a desired location of the keyboard membrane to a keyboard dome.

In some examples, the keyboard membrane comprises a plurality of guiding openings positioned to guide a plurality of keyboard domes simultaneously to a respective location of the keyboard membrane. Having a plurality of guiding openings on a membrane cover may provide benefits such as reducing a number of membrane covers being utilized to complete an assembly of the keyboard domes to the keyboard membrane.

It will be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

In the foregoing detailed description of the disclosure, reference is made to the accompanying drawings that form a part hereof, and in which is shown by way of illustration how examples of the disclosure may be practiced. These examples are described in sufficient detail to enable those in the art to practice the examples of this disclosure, and it is to be understood that other examples (e.g., having different thickness) may be utilized and that process, electrical, and/or structural changes may be made without departing from the scope of the disclosure.

The figures herein follow a numbering convention in which the first digit corresponds to the drawing figure number and the remaining digits identify an element or component in the drawing. For example, reference numeral 110 may refer to element 110 in FIG. 1 and an analogous element may be identified by reference numeral 210 in FIG. 2. Elements shown in the various figures herein can be added, exchanged, and/or eliminated so as to provide a number of additional examples of the disclosure. The proportion and the relative scale of the elements provided in the figures are intended to illustrate the examples of the disclosure, and should not be taken in a limiting sense. As used herein, “a number of” an element and/or feature can refer to one or more of such elements and/or features.

What is claimed:

1. A keyboard dome, comprising:
a dome with an exterior surface; and
a metal magnetic pad on the exterior surface of the dome to guide the dome to a keyboard membrane.

2. The keyboard dome of claim 1, wherein the metal magnetic pad is non-removably coupled to the first exterior surface of the dome to prevent the dome from being inadvertently removed from the keyboard membrane when the dome is guided and coupled to the keyboard membrane via the metal magnetic pad.

3. The keyboard dome of claim 1, wherein the metal magnetic pad covers a portion of the first exterior surface.

4. The keyboard dome of claim 1, wherein the metal magnetic pad is substantially less thick than the first exterior surface.

5. The keyboard dome of claim 1, wherein the dome is comprised of a resilient material.

6. The keyboard dome of claim 5, wherein the resilient material is further comprised of a rubber, silicon rubber, or a combination thereof.

7. An apparatus, comprising:
a keyboard membrane; and
a keyboard dome positioned on a particular location of the keyboard membrane, wherein the keyboard dome comprises a metal magnetic pad to guide the keyboard dome to the particular location of the keyboard membrane.

8. The apparatus of claim 7, wherein the metal magnetic pad is positioned on a first exterior surface of the keyboard dome to contact and non-removably couple the key board dome to the particular location of the keyboard membrane.

9. The apparatus of claim t, wherein the keyboard membrane comprises a membrane cover placed on the keyboard membrane, wherein the membrane cover comprises a guiding opening.

10. The apparatus of claim 9, wherein the membrane cover comprises a plurality of guiding openings to guide a plurality of keyboard domes to a respective location of the keyboard membrane.

11. A method, comprising:
selectively generating a magnetic field on a particular location of a keyboard membrane to attract a metal magnetic pad of a keyboard dome; and
magnetically guiding the metal magnetic pad of the keyboard dome to the particular location of the keyboard membrane.

12. The method of claim 11, wherein the method includes:
providing a first membrane cover including a guiding opening to guide the keyboard dome to the particular location of the keyboard membrane via the guiding opening; and
placing the first membrane cover on the keyboard membrane such that the particular location is exposed to the keyboard dome via the guiding opening.

13. The method of claim 12, magnetically guiding the metal magnetic pad of the keyboard dome to the particular location of the keyboard membrane via the guiding opening of the membrane cover.

14. The method of claim 12, wherein the method includes providing a second membrane cover for another keyboard dome with a different shape, wherein the second membrane cover includes a guiding opening of a different shape and/or positioned on a different location of the second membrane cover to guide the particular keyboard dome with a variety of different shapes to a respective location of the keyboard membrane.

15. The apparatus of claim 12, wherein simultaneously guiding a plurality of keyboard domes to a respective location of the keyboard membrane.
